(19) United States
(12) Patent Application Publication
(10) Pub. No.: US 2008/0246759 A1
(43) Pub. Date: Oct. 9, 2008

(54) Automatic Scene Modeling for the 3D Camera and 3D Video

(76) Inventor: Craig Summers, Glen Haven (CA)

Correspondence Address: QUARLES & BRADY LLP, 411 E. WISCONSIN AVENUE, SUITE 2040, MILWAUKEE, WI, 53202-4497, US

(21) Appl. No.: 11/816,978

(22) PCT Filed: Feb. 23, 2006
(86) PCT No.: PCT/CA06/00265

§ 371 Date: Jun. 18, 2008

Related U.S. Application Data
(60) Provisional application No. 60/655,514, filed on Feb. 23, 2005.

(51) Int. Cl. G06T 17/00; G06T 17/20; G06T 15/00; G06T 7/20; G06T 5/00; A63F 13/00; H04N 13/02; H04N 5/262

(52) U.S. Cl. 345/420; 345/419; 382/106; 348/14.01; 345/158; 382/154; 348/E07.083

(57) ABSTRACT

Single-camera image processing methods are disclosed for 3D navigation within ordinary moving video. Along with color and brightness, XYZ coordinates can be defined for every pixel. The resulting geometric models can be used to obtain measurements from digital images, as an alternative to on-site surveying and equipment such as laser range-finders. Motion parallax is used to separate foreground objects from the background. This provides a convenient method for placing video elements within different backgrounds, for product placement, and for merging video elements with computer-aided design (CAD) models and point clouds from other sources. If home users can save video fly-throughs or specific 3D elements from video, this method provides an opportunity for proactive, branded media sharing. When this image processing is used with a videoconferencing camera, the user's movements can automatically control the viewpoint, creating 3D hologram effects on ordinary televisions and computer screens.

### FIELD OF INVENTION

This invention is directed to image-processing technology and, in particular, the invention is directed to a system and method that automatically segments image sequences into navigable 3D scenes.

### BACKGROUND OF THE INVENTION

Virtual tours have to this point been the biggest application of digital images to 3D navigation. There are a number of photo-VR methods, from stitching photos into panoramas to off-the-shelf systems that convert two fisheye shots into a spherical image, to parabolic mirror systems that capture and unwarp a 360-degree view. Unfortunately, these approaches are based on nodal panoramas constrained to one viewpoint for simple operation. They all allow on-screen panning to look around in a scene and zooming in until the image pixellates. But even though a 3D model underlies the scene in each case, there is no ability to move around in the 3D model, no ability to incorporate foreground objects, and no depth perception from parallax while foreground objects move relative to the background.

The limitations get worse with 360-degree video. Even with the most expensive, high resolution cameras that are made, the resolution in video is inadequate for panoramic scenes. Having the viewpoint fixed in one place also means that there is no motion parallax. When we move in real life, objects in the foreground move relative to objects in the background. This is a fundamental depth cue in visual perception.

An alternative approach is to use a 3D rendering program to create a 3D object model. However, this is ordinarily a time-consuming approach that requires expensive computer hardware and software and extensive training. Plus, the state of the art for 3D rendering and animation is cartoon-like objects. Therefore, there is a need to create and view photorealistic 3D models. In addition, the method should be quick and inexpensive.

The standard practice with the current generation of photomodeling and motion-tracking software is to place markers around an object or to have the user mark out the features and vertices of every flat surface, ensuring that corresponding points are marked in photos from different perspectives. Yet creating point clouds by hand one point at a time is obviously slow. While realistic shapes can be manually created for manufactured objects, this also does not work well for soft gradients and contours on organic objects.

Bracey, G. C., Goss, M. K. and Goss, Y. N. (2001) filed an international patent application, entitled “3D Game Avatar Using Physical Characteristics” having international publication number WO 01/63560 for marking several profiles of a face to create a 3D head model. While the invention disclosed herein can be used to create a similar outcome, it is generated automatically without manual marking. Photogrammetry methods such as the head-modeling defined by Bracey et al. depend on individually marking feature points in images from different perspectives. Although Bracey et al. say that this could be done manually or with a computer program, recognizing something that has a different shape from different views is a fundamental problem of artificial intelligence that has not been solved computationally. Bracey et al. do not specify any method for solving this long-standing problem. They do not define how a computer program could “recognize” an eyebrow as being the same object when viewed from the front and from the side. The method they do describe involves user intervention to manually indicate each feature point in several corresponding photos. The objective of the method disclosed by Bracey et al. seems to be texture mapping onto a predefined generic head shape (wireframe) rather than actual 3D modeling. Given the impact that hair has on the shape and appearance of a person's head, imposing photos on an existing mannequin-type head with no hair is an obvious shortcoming. The method of the present invention will define wireframe objects (and texture maps) for any shape.

Bracey et al. also do not appear to specify any constraints on which corresponding feature points to use, other than to typically mark at least 7 points. The method disclosed here can match any number of pixels from frame to frame, and does so with very explicit methods. The method of the present invention can use either images from different perspectives or motion parallax to automatically generate a wireframe structure. Contrary to Bracey et al., the method of the present invention is meant to be automatically done by a computer program, and is rarely done manually. The method of the present invention will render entire scenes in 3D, rather than just heads (although it will also work on images of people including close-ups of heads and faces). The method of the present invention does not have to use front and side views necessarily, as do Bracey et al. The Bracey et al. manual feature marking method is similar to existing commercial software for photo-modeling, although Bracey et al. are confined to texture-mapping and only to heads and faces.

Specialized hardware systems also exist for generating 3D geometry from real-life objects, although all tend to be labor-intensive and require very expensive equipment:
Stereo Vision: Specialized industrial cameras exist with two lens systems calibrated a certain distance apart. These are not for consumer use, and would have extra costs to manufacture. The viewer ordinarily requires special equipment such as LCD shutter glasses or red-green 3D glasses.
Laser Range Finding: Lines, dots or grids are projected onto an object to define its distance or shape using light travel time or triangulation when specific light points are identified. This approach requires expensive equipment, is based on massive data sets, is slow and is not photorealistic.

These setups involve substantial costs and inconvenience with specialized hardware, and tend to be suited to small objects, rather than objects like a building or a mountain range.

From the applied research and product development in all of these different areas, there still appear to be few tools to generate XYZ coordinates automatically from XY coordinates in image sequences. There are also no accessible tools for converting from XYZ points to a 3D surface model. There is no system on the market that lets people navigate on their own through moving video—whether for professionals or at consumer levels. There is also no system available that generates a geometric model from video automatically. There is also no system that works on photos or video, and no system that will automatically generate a geometric model from just a few images automatically without manual marking of matching targets in comparison pictures. Finally, specialized approaches such as laser range finding, stereoscopy, various forms of 3D rendering and photogrammetry have steep equipment, labor and training costs, putting the technology out of range for consumers and most film-makers outside a few major Hollywood studios.

In broadcasting and cinematography, the purpose of extracting matte layers is usually to composite together interchangeable foreground and background layers. For example, using a green-screen studio for nightly weather broadcasts, a map of the weather can be digitally placed behind the person talking. Even in 1940's cinematography, elaborate scene elements were painted on glass and the actors were filmed looking through this “composited” window. In the days before digital special effects, this “matte painting” allowed the actors to be filmed in an ordinary set, with elaborate room furnishings painted onto the glass from the camera's perspective. Similar techniques have traditionally been used in cell animation, in which celluloid sheets are layered to redraw the foreground and background at different rates. Also historically, Disney's multiplane camera was developed to create depth perception by having the viewpoint zoom in through cartoon elements on composited glass windows.

By using motion parallax to infer depth in digital image sequences, the methods disclosed here can separate foreground objects from the background without specialized camera hardware or studio lighting. Knowing X, Y and Z coordinates to define a 3D location for any pixel, we are then able to allow the person viewing to look at the scene from other viewpoints and to navigate through the scene elements. Unlike photo-based object movies and panoramic VR scenes, this movement is smooth without jumping from frame to frame, and can be a different path for each individual viewer. The method of the present invention allows for the removal of specific objects that have been segmented in the scene, the addition of new 3D foreground objects, or the ability to map new images onto particular surfaces, for example replacing a picture on a wall. In an era when consumers are increasingly able to bypass the traditional television commercial ad model, this is a method of product placement in real-time video. If home users can save video fly-throughs or specific 3D elements from running video, this method can therefore enable proactive, branded media sharing.

When used with a digital videoconferencing camera (or “web cam”), we can follow the user's movements, and change the viewpoint in video that they are watching. This provides the effect of 3D holograms on ordinary television and computer monitors. One outcome is interactive TV that does not require active control; the viewpoint moves automatically when the user does. The user can watch TV passively, yet navigate 3D replays and/or look around as the video plays, using gestures and body movements.

Therefore, there is a need for a method that automatically segments two-dimensional image sequences into navigable 3D scenes.

### SUMMARY OF THE INVENTION

The present invention is directed to a method and system that automatically segments two-dimensional image sequences into navigable 3D scenes that may include motion.

The methods disclosed here use “motion parallax” to segment foreground objects automatically in running video, or use silhouettes of an object from different angles, to automatically generate its 3D shape. “Motion parallax” is an optical depth cue in which nearer objects move laterally at a different rate and amount than the optical flow of more distant background objects. Motion parallax can be used to extract “mattes”: image segments that can be composited in layers. This does not require the specialized lighting of blue-screen matting, also known as chromakeying, the manual tracing on keyframes of “rotoscoping” cinematography methods, or manual marking of correspondence points. The motion parallax approach also does not require projecting any kind of grid, line or pattern onto the scene. Because this is a single-camera method for automatic scene modeling for 3D video, this technology can operate within a “3D camera”, or can be used to generate a navigable 3D experience in the playback of existing or historical movie footage. Ordinary video can be viewed continuously in 3D with this method, or 3D elements and fly-throughs can be saved and shared on-line.

The image-processing technology described in the present invention is illustrated in FIG. 1. It makes a balance of what is practical with achieving 3D effects in video that satisfy the eye with a rich 3D, moving, audio-visual environment. Motion parallax is used to add depth (Z) to each XY coordinate point in the frame, to produce single-camera automatic scene modeling for 3D video. While designed to be convenient since it is automatic and cost effective for consumers to use, it also opens up an entire new interface for what we traditionally think of as motion pictures, in which the movie can move, but the viewing audience can move as well. Movies could be produced anticipating navigation within and between scenes. But even without production changes, software for set-top boxes and computers could allow any video signal to be geometrically rendered with this system.

For convenience, Z is used to refer to the depth dimension, following the convention of X for the horizontal axis and Y for the vertical axis in 2D coordinate systems. However, these labels are somewhat arbitrary and different symbols could be used to refer to the three dimensions.

The basic capability to generate 3D models from ordinary video leads to two other capabilities as well. If we can generate geometric structures from video, we must know the 3D coordinates of specific points in frames of video. We can therefore extract distances, volumes and other measures from objects in the video, which allows this image processing to be used in industrial applications.

The second capability that then becomes possible involves on-screen hologram effects. If running video is separated into a moving 3D model, a viewpoint parameter will need to define the XYZ location and direction of gaze. If the person viewing is using a web cam or video camera, their movement while viewing could be used to modify the viewpoint parameter in 3D video, VR scenes or 3D games. Then, when the person moves, the viewpoint on-screen moves automatically, allowing them to see around foreground objects. This produces an effect similar to a 3D hologram using an ordinary television or computer monitor.

In the broadest sense, it is an object of the method disclosed herein to enable the “3D camera”: for every pixel saved, we can also define a location in XYZ coordinates. This goes beyond a bitmap from one static viewpoint, and provides the data and capabilities to analyze scene geometry to produce a fuller 3D experience. The image processing could occur with the image sensor in the camera, or at the point of display. Either way, the system described herein can create a powerful viewing experience on ordinary monitor screens, with automatic processing of ordinary video. No special camera hardware is needed. It uses efficient methods to generate scenes directly from images rather than the standard approach of attempting to render millions of polygons into a realistic scene.

Accordingly, it is an object of the present invention to identify foreground objects based on differential optic flow in moving video, and then to add depth (Z) to each XY coordinate point in the frame.

It is another object of the present invention to allow product placement in which branded products are inserted into a scene, even with dynamic targeting based on demographics or other variables such as weather or location.

It is an additional object of the present invention to create a system that allows image processing which leads to 3D models which have measurable dimensions.

It is also an object of the present invention to process user movement from a web cam when available, to control the viewpoint when navigating onscreen in 3D.

Ordinarily with 3D modeling, the premise is that visual detail must be minimized in favor of a wireframe model. Even so, rendering the “fly-throughs” for an animated movie (i.e., recording of navigation through a 3D scene) requires processing of wireframes containing millions of polygons on giant “render farms”: massive multi-computer rendering of a single fly-through recorded onto linear video. In contrast, the method and software described herein takes a very different approach to the premises for how 3D video should be generated. The methods defined here are designed to relax the need for complex and precise geometric models, in favor of creating realism with minimal polygon models and rich audio-video content. This opens up 3D experiences so that anyone could create a fly-through on a home computer. Ordinary home computers or set-top boxes are sufficient, rather than industrial systems that take hours or days to render millions of wireframe surfaces to generate a 3D fly-through.

The methods disclosed here are designed to generate a minimal geometric model to add depth to the video with moderate amounts of processing, and simply run the video mapped onto this simplified geometric model. No render farm is required. Generating only a limited number of geometric objects makes the rendering less computationally intensive and makes the texture-mapping easier. While obtaining 3D navigation within moving video from ordinary one-camera linear video this way, shortcomings of the model can be overcome by the sound and motion of the video.

We now have the technical capability to change the nature of what it means to “take a picture”. Rather than storing a bitmap of color pixels, a “digital image” could also store scene geometry. Rather than emulating the traditional capability to record points of color as in paintings, digital imaging could include 3D structure as well as the color points. The software is thus capable of changing the fundamental nature of both the picture-taking and the viewing experience.

Using the methods described here, foreground objects can be modeled, processed and transmitted separate from the background in video. Imagine navigating through 3D video as it plays. As you use an ordinary video camera, perhaps some people walk in to the scene. Then, when you view the video, they could be shown walking around in the 3D scene while you navigate through it. The interface would also allow you to freeze the action or to speed it up or reverse it, while you fly around. This would be like a frozen-in-time spin-around effect, however in this case you can move through the space in any direction, and can also speed up, pause or reverse the playback. Also, because we can separate foreground and background, you can place the people in a different 3D environment for their walk.

Astronomers have long been interested in using motion parallax to calculate distances to planets and stars, by inferring distance in photos taken from different points in the earth's rotation through the night or in its annual orbit. The image processing disclosed here also leads to a new method of automatically generating navigable 3D star models from series of images taken at different points in the earth's orbit.

This paradigm shift in the nature of the viewing experience that is possible—from linear video, with one camera, on a flat television screen or monitor—could fundamentally change how we view movies and the nature of motion picture production. Even the language we have to refer to these capabilities is limited to terms like “film”, “movie” and “motion picture”, none of which fully express the experience of non-linear video that can be navigated while it plays. It is not even really a “replay” in the sense that your experience interacting in the scene could be different each time.

As well as opening up new possibilities for producers and users of interactive television, the ability to separate foreground objects contributes to the ability to transmit higher frame-rates for moving than static objects in compression formats such as MPEG-4, to reduce video bandwidth.

### BRIEF DESCRIPTION OF THE DRAWINGS

The following detailed description, given by way of example and not intended to limit the present invention solely thereto, is best understood in conjunction with the accompanying drawings of which:

FIG. 1: shows a schematic illustration of the overall process: a foreground object matte is separated from the background, a blank area is created where the object was (when viewed from a different angle), and a wireframe is added to give thickness to the foreground matte;

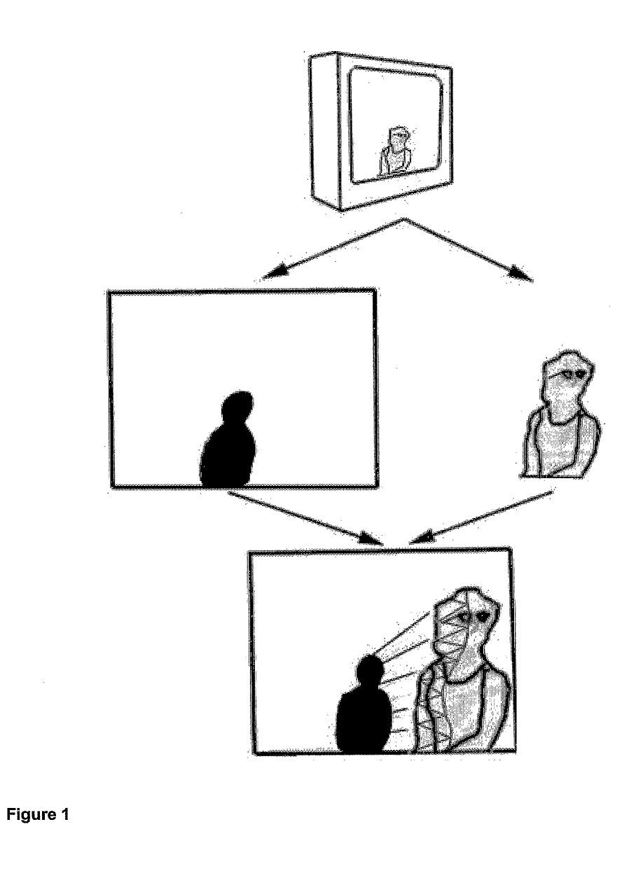

FIG. 2: shows an on-screen hologram being controlled with the software of the present invention which detects movement of the user in feedback from the web cam, causing the viewpoint to move on-screen;

FIG. 3: shows a general flow diagram of the processing elements of the invention;

FIG. 4: shows two photos of a desk lamp from different perspectives, from which 3D model is rendered;

FIG. 5: shows a 3D model of desk lamp created from two photos. Smoothed wireframe model is shown at left. At right is the final 3D object with the images mapped onto the surface. Part of the back of the object is hollow that was not visible in original photos, although that surface could be closed;

FIG. 6: shows a method for defining triangular polygons on the XYZ coordinate points, to create the wireframe mesh;

FIG. 7: shows angled view of separated video showing shadow on background.

### PREFERRED EMBODIMENT OF THE INVENTION

A better viewing experience would occur with photos and video if depth geometry was analyzed in the image processing along with the traditional features of paintings and images, such as color and contrast. Rather than expressing points of color on a two-dimensional image as in a photo, a painting or even in cave drawings, the technology disclosed here processes 3D scene structure. It does so from ordinary digital imaging devices, whether still or video cameras. The processing could occur in the camera, but ordinarily will happen with the navigation at the viewer. This processing occurs automatically, without manual intervention. It even works with historic movie footage.

Typically in video there will be scene changes and camera moves that will affect the 3D structure. Overall optical flow can be used as an indicator of certain types of camera movement; for example, swiveling of the camera around the lens' nodal point would remove parallax and cause flattening of the 3D model. Lateral movement of the camera would enhance motion parallax and the pop-out of foreground objects. A moving object could also be segmented based on differential motion in comparison to the overall optic flow. That may not be bad for the viewing experience, although a sensitivity control could allow the user to turn down the amount of pop out. When the video is played back in 3D coordinates, by default it is set on the same screen area as the initial video that was captured.

Unlike all virtual tours currently in use, this system allows the user to move within a photorealistic environment, and to view it from any perspective, even where there was never a camera. Distance measures can be pulled out of the scene because of the underlying 3D model.

One embodiment of the present invention is based on automatic matte extraction in which foreground objects are segmented based on lateral movement at a different rate than background optical flow (i.e., motion parallax). However, there is a common variation that will be disclosed as well. Some image sequences by their nature do not have any motion in them; in particular, orthogonal photos such as a face- and side-view of a person or object. If two photos are taken at 90-degree or other specified perspectives, the object shape can still be rendered automatically, with no human intervention. As long as the photos are taken in a way that the background can be separated—either with movement, chromakeying or manual erasure of the background—two silhouettes in different perspectives are sufficient to define the object, inflate it, and texture map the images onto the resulting wireframe. This process can be entirely automatic if the background can be keyed out, and if the photos are taken at pre-established degrees of rotation. If the photos are not taken at pre-established amounts of rotation, it is still possible to specify the degrees of rotation of the different perspectives in a user interface. Then, trigonometric formulae can be used to calculate the X, Y and Z coordinates of points to define the outer shape of the wireframe in three dimensions.

The image processing system disclosed here can operate regardless of the type of image capture device, and is compatible with digital video, a series of still photos, or stereoscopic camera input for example. It has also been designed to work with panoramic images, including when captured from a parabolic mirror or from a cluster of outward-looking still or video cameras. Foreground objects from the panoramic images can be separated, or the panorama can serve as a background into which other foreground people or objects can be placed. Rather than generating a 3D model from video, it is also possible to use the methods outlined here to generate two different viewpoints to create depth perception with a stereoscope or red-green, polarized or LCD shutter glasses. Also, a user's movements can be used to control the orientation, viewing angle and distance of the viewpoint for stereoscopic viewing glasses.

The image processing in this system leads to 3D models which have well-defined dimensions. It is therefore possible to extract length measurements from the scenes that are created. For engineers and realtors, for example, this technology allows dimensions and measurements to be generated from digital photos and video, without going onsite and physically measuring or surveying. For any organization or industry needing measurements from many users, data collection can be decentralized with images submitted for processing or processed by many users, without need for scheduling visits involving expensive measurement hardware and personnel. The preferred embodiment involves the ability to get dimensional measurements from the interface, including point-to-point distances that are indicated, and also volumes of objects rendered.

Using motion parallax to obtain geometric structure from image sequences is also a way to separate or combine navigable video and 3D objects. This is consistent with the objectives of the new MPEG-4 digital video standard, a compression format in which fast-moving scene elements are transmitted with a greater frame rate than static elements. The invention being disclosed allows product placement in which branded products are inserted into a scene—even with personalized targeting based on demographics or other variables such as weather or location (see method description in Phase 7).

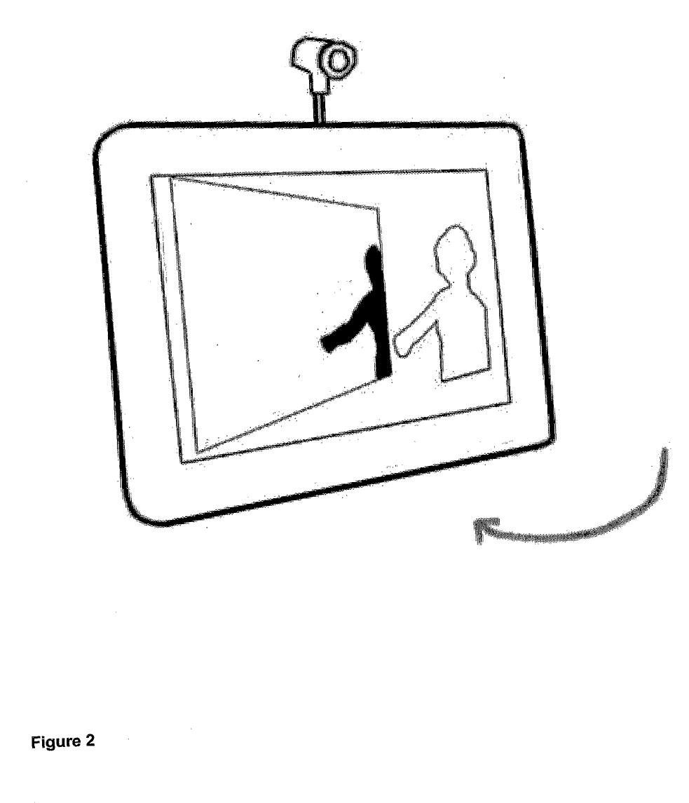

The software can also be used to detect user movement with a videoconferencing camera (often referred to as a “web cam”), as a method of navigational control in 3D games, panoramic VR scenes, computer desktop control or 3D video. Web cams are small digital video cameras that are often mounted on computer monitors for videoconferencing. With the invention disclosed here, the preferred embodiment is to detect the user's motion in the foreground, to control the viewpoint in a 3D videogame on an ordinary television or computer monitor, as seen in FIG. 2. The information on the user's movement is sent to the computer to control the viewpoint during navigation, adding to movement instructions coming from the mouse, keyboard, gamepad and/or joystick. In the preferred embodiment, this is done through a driver installed in the operating system, that converts body movement from the web cam to be sent to the computer in the form of mouse movements, for example. It is also possible to run the web cam feedback in a dynamic link library (DLL) and/or an SDK (software development kit) that adds capabilities to the graphics engine for a 3D game. Those skilled in the art will recognize that the use of DLLs and SDKs is a common procedure in computer programming. Although the preferred embodiment uses a low-cost digital web cam, any kind of digitized video capture device would work.

Feedback from a web cam could be set to control different types of navigation and movement, either within the image processing software or with the options of the 3D game or application being controlled. In the preferred embodiment, when the user moves left-right or forward-back, it is the XYZ viewpoint parameter that is moved accordingly. In some games such as car racing, however, moving left-right in the game changes the viewpoint and also controls navigation. As in industry standards such as VRML, when there is a choice of moving through space or rotating an object, left-right control movement causes whichever type of scene movement the user has selected. This is usually defined in the application or game, and does not need to be set as part of the web cam feedback.

The methods disclosed here can also be used to control the viewpoint based on video input when watching a movie, sports broadcast or other video or image sequence, rather than navigating with mouse. If the movie is segmented by the software detecting parallax, we would also be using software with the web cam to detect user motion. Then, during the movie playback, the viewpoint could change with user movement or via mouse control.

In one embodiment, when the web cam is not used, movement control can be set for keyboard keys and mouse movement allowing the user to move around through a scene using the mouse while looking around using the keyboard or vice versa.

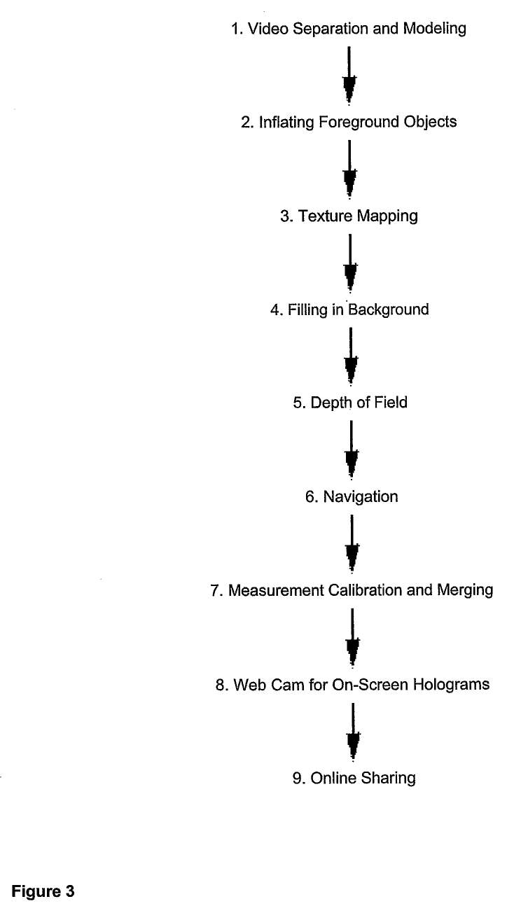

The main technical procedures with the software are illustrated in the flowchart in FIG. 3. These and other objects, features and advantages of the present invention should be fully understood by those skilled in the art from the description of the following nine phases.

### Phase 1: Video Separation and Modeling

In a broad aspect, the invention disclosed here processes the raw video for areas of differential movement (motion parallax). This information can be used to infer depth for 3D video, or when used with a web cam, to detect motion of the user to control the viewpoint in 3D video, a photo-VR scene or 3D video games.

One embodiment of the motion detection from frame to frame is based on checking for pixels and/or sections of the image that have changed in attributes such as color or intensity. Tracking the edges, features, or center-point of areas that change can be used to determine the location, rate and direction of movement within the image. The invention may be embodied by tracking any of these features without departing from the spirit or essential characteristics thereof.

Edge detection and optic flow are used to identify foreground objects that are moving at a different rate than the background (i.e., motion parallax). Whether using multiple (or stereo) photos or frames of video, the edge detection is based on the best match for correspondence of features such as hue, RGB value or brightness between frames, not on absolute matches of features. The next step is to generate wireframe surfaces for background and foreground objects. The background may be a rectangle of video based on the dimensions of the input, or could be a wider panoramic field of view (e.g., cylindrical, spherical or cubic), with input such as multiple cameras, a wide-angle lens, or parabolic mirror. The video is texture-mapped onto the surfaces rendered. It is then played back in a compatible, cross-platform, widely available modeling format (including but not limited to OpenGL, DirectX or VRML), allowing smooth, fast navigation moving within the scene as it plays.

In order to evaluate relative pixel movement between frames, one embodiment in the low-level image processing is to find the same point in both images. In computer vision research, this is known as The Correspondence Problem. Information such as knowledge of camera movement or other optic flow can narrow the search. By specifying on what plane the cameras are moved or separated (i.e., horizontal, vertical, or some other orientation), the matching search is reduced. The program can skip columns, depending on the level of resolution and processing speed required to generate the 3D model.

The amount of pixel separation in the matching points is then converted to a depth point (i.e., Z coordinate), and written into a 3D model data file (e.g., in the VRML 2.0 specification) in XYZ coordinates. It is also possible to reduce the size of the images during the processing to look for larger features with less resolution and as such, reduce the processing time required. The image can also be reduced to grayscale, to simplify the identification of contrast points (a shift in color or brightness across two or a given number of pixels). It is also a good strategy to only pull out sufficient distance information. The user will control the software application to look for the largest shifts in distance information, and only this information. For pixel parallax smaller than the specified range, simply define those parts of the image as background. Once a match is made, no further searching is required.

Also, credibility maps can be assessed along with shift maps and depth maps for more accurate tracking of movement from frame to frame. The embossed mattes can be shown to remain attached to the background or as separate objects that are closer to the viewer.

There are a number of variables that are open to user adjustment: a depth adjuster for the degree of popout between the foreground layer and background; control for keyframe frequency; sensitivity control for inflation of foreground objects; and the rate at which the wire frame changes. Depth of field is also an adjustable parameter (implemented in Phase 5). The default is to sharpen foreground objects to give focus and further distinguish them from the background (i.e., shorten depth of field). Background video can then be softened and lower resolution and if not panoramic, mounted on the 3D background so that it is always fixed and the viewer cannot look behind it. As in the VRML 2.0 specification, the default movement is always in XYZ space in front of the background.

### Phase 2: Inflating Foreground Objects

When an object is initially segmented based on the raw video, a data set of points is created (sometimes referred to as a “point cloud”). These points can be connected together into surfaces of varying depths, with specified amounts of detail based on processor resources. Groups of features that are segmented together are typically defined to be part of the same object. When the user moves their viewpoint around, the illusion of depth will be stronger if foreground objects have thickness. Although the processing of points may define sufficiently detailed depth maps, it is also possible to give depth to foreground objects by creating a center spine and pulling it forward in proportion to the width. Although this is somewhat primitive, this algorithm is fast for rendering in moving video, and it is likely that the movement and audio in the video stream will overcome any perceived deficiencies.

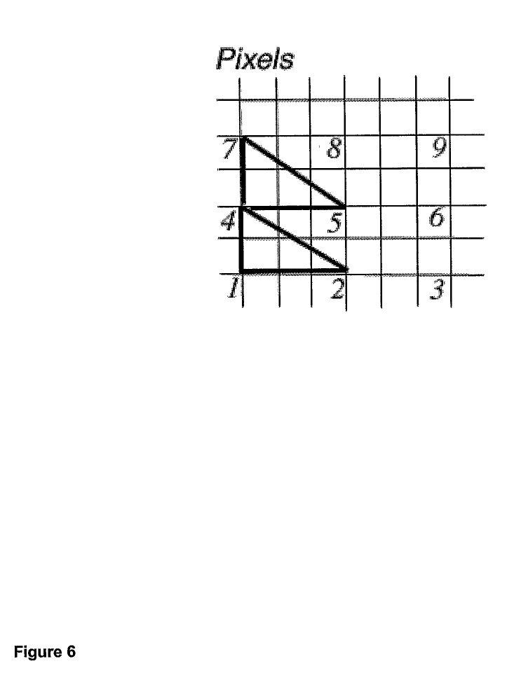

To convert from a point cloud of individual XYZ data points to a wireframe mesh, our method is to use triangles for the elements of the mesh to ensure that all polygons are perfectly flat. Triangles can be used to create any shape, and two triangles can be put together to make a square. To construct the wire mesh out of triangles, the algorithm begins at the bottom of the left edge of the object (point 1 in FIG. 6). In the simplest case, there are 3 sets of points defining the shape on one side: XYZ for the left edge (point 1), XYZ for the center thickness (point 2), and XYZ for the right edge (point 3) as illustrated in FIG. 6. Beginning with the bottom row of pixels, we put a triangle between the left edge and the center (1-2-4). Then, we go back with a second triangle (5-4-2) that with the first triangle (1,2,4) forms a square. This is repeated up the column to the top of the object, first with the lower triangles (1-2-4, 4-5-7, 7-8-10 . . . ) and then with the upper triangles (8-7-5, 5-4-2 . . . ). Then, the same method is used going up and then down the right column. Knowing that there are three (or any particular number of) points across the object, the numbering of each of the corners of the triangle can then be automated, both for the definition of the triangles and also for the surface mapping of the image onto the triangles. We define the lower left coordinate to be “1”, the middle to be “2” and the right edge to be “3”, and then continue numbering on each higher row. This is the preferred method but the skilled person in the art would appreciate that counting down the rows or across columns would of course also be possible.

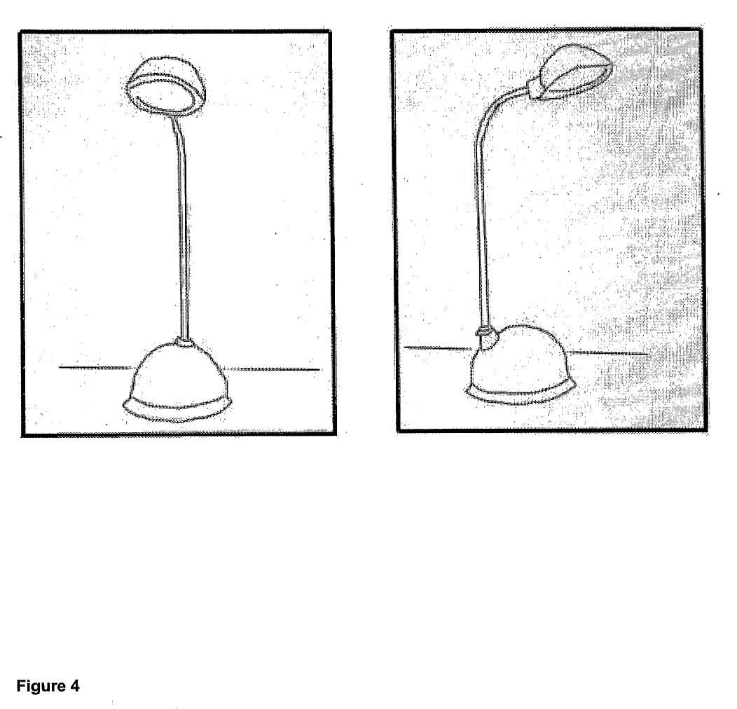

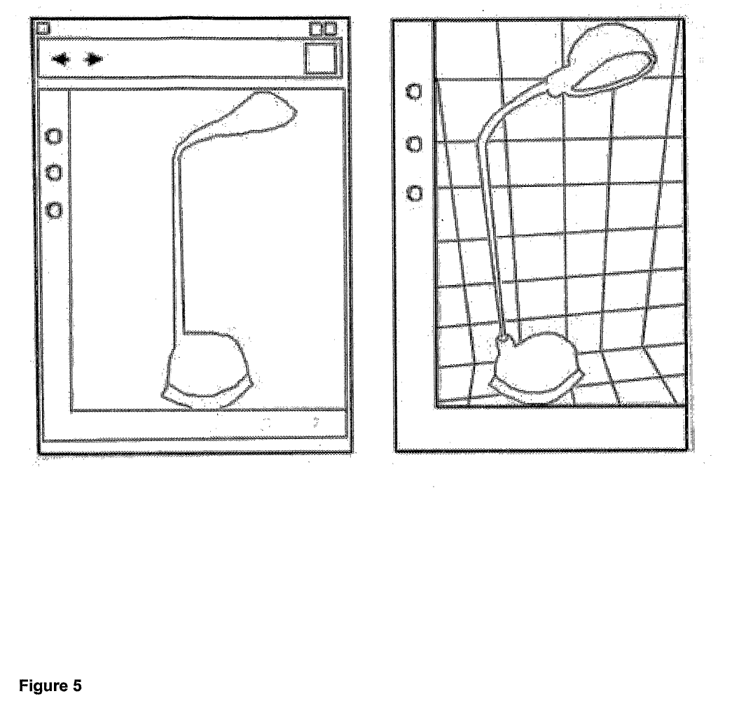

In one embodiment, the spine is generated on the object to give depth in proportion to width, although a more precise depth map of object thickness can be defined if there are side views from one or more angles as can be seen from in FIG. 4. In this case, the software can use the silhouette of the object in each picture to define the X and Y coordinates (horizontal and vertical, respectively), and uses the cross sections at different angles to define the Z coordinate (the object's depth) using trigonometry. As illustrated in FIG. 5, knowing the X, Y and Z coordinates for surface points on the object allows the construction of the wireframe model and texture-mapping of images onto the wireframe surface. If the software cannot detect a clean edge for the silhouette, drawing tools can be included or third-party software can be used for chromakeying or masking. If the frames are spaced closely enough, motion parallax may be sufficient. In order to calibrate both pictures, the program may reduce the resolution and scale the pictures to the same height. The user can also indicate a central feature or the center of gravity for the object, so that the Z depths are from the same reference in both pictures. By repeating this method for each photo, a set of coordinates from each perspective is generated to define the object. These coordinates can be fused by putting them into one large data set on the same scale. The true innovative value of this algorithm is that only the scale and rotation of cameras is required for the program to generate the XYZ coordinates.

When a limited number of polygons are used, the model that is generated may look blocky or angular. This may be desired for manufactured objects like boxes, cars or buildings. But for organic objects like the softness of a human face or a gradient of color going across a cloud, softer curves are needed. The software accounts for this with a parameter in the interface that adjusts the softness of the edge at vertices and corners. This is consistent with a similar parameter in the VRML 2.0 specification.

### Phase 3: Texture Mapping

Once we have converted from the point cloud to the wireframe mesh, there is still a need to get the images onto the 3D surface. The relevant XY coordinates for sections of each frame are matched to coordinates in the XYZ model as it exists at that time (by dropping the Z coordinate and retaining X and Y). Then, using an industry-standard modeling format such as, but not limited to, OpenGL, DirectX or VRML (Virtual Reality Modeling Language), the video is played on the surfaces of the model. This method is also consistent with separating video layers (based on BIFS: the Binary Format for Scenes) in the MPEG-4 standard for digital video. (MPEG is an acronym referring to the Motion Picture Experts Group, an industry-wide association that defines technology standards.)

The method used here for mapping onto a wireframe mesh is consistent with the VRML 2.0 standard. The convention for the surface map in VRML 2.0 is for the image map coordinates to be on a scale from 0 to 1 on the horizontal and vertical axes. A coordinate transformation therefore needs to be done, from XYZ. The Z is omitted, and X and Y are converted to decimals between 0 and 1. This defines the stretching and placement of the images to put them in perspective. If different images overlap, this is not a problem, since they should be in perspective, and should merge together.

This method is also innovative in being able to take multiple overlapping images, and apply them in perspective to a 3D surface without the additional step of stitching the images together. When adjacent photos are stitched together to form a panorama, they are usually manually aligned and then the two images are blended. This requires time, and in reality often leads to seam artifacts. One of the important innovations in the approach defined here is that it does not require stitching. The images are mapped onto the same coordinates that defined the model.

### Phase 4: Filling in Background

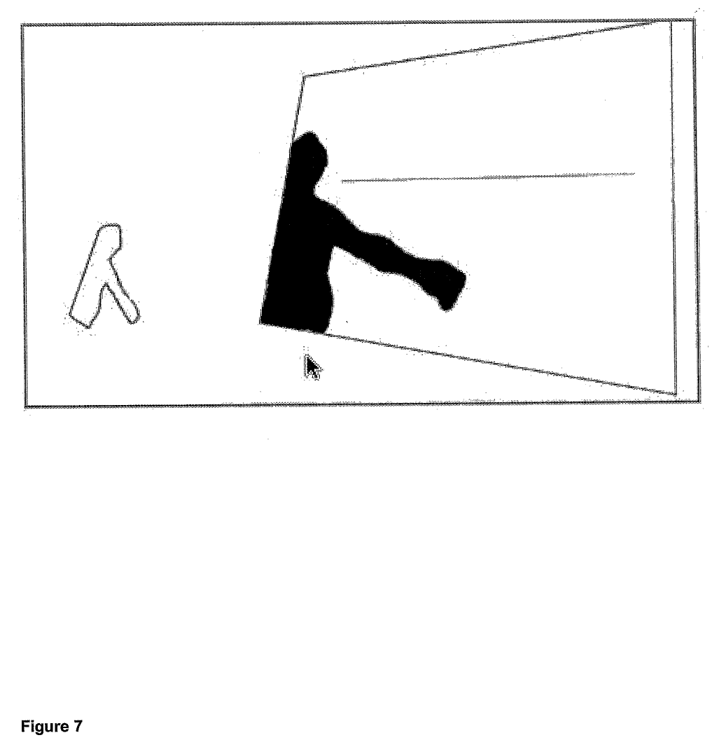

As can be seen from FIG. 7, when an object is pulled into the foreground, it leaves a blank space in the background that is visible when viewed from a different perspective. Ideally, when the viewpoint moves, you can see behind foreground objects and people but not notice any holes in the background. The method disclosed here begins by filling in the background by stretching the edges to pull in the peripheral colors to the center of the hole. Since the surface exists, different coordinates are simply used to fit the original image onto a larger area, stretching the image to cover the blank space. It will be appreciated by those skilled in the art that variations may be accomplished in view of these explanations without deviating from the spirit or scope of the present invention.

The same process can also be applied to objects where a rear section or the top and bottom is not visible to the camera. It is possible to link the edges of the hole by generating a surface. Then, surrounding image segments can be stretched in. As more of that section becomes more visible in the input images, more surface could also be added.

### Phase 5: Depth of Field

Sharpen the foreground and soften or blur the background, to enhance depth perception. It will be apparent to one skilled in the art that there are standard masking and filtering methods such as convolution masks to exaggerate or soften edges in image processing, as well as off-the-shelf tools that implement this kind of image processing. This helps to hide holes in the background and lowers the resolution requirements for the background. This is an adjustable variable for the user.

### Phase 6: Navigation

Once the final 3D model is generated, there are a number of ways that it can be viewed and used. For navigation, the procedures described in this document are consistent with standards such as VRML 2.0. It should be clear to those skilled in the art how to format the resulting video file and 3D data for 3D modeling and navigation using publicly-available standard requirements for platforms such as VRML 2.0, OpenGL, or DirectX.

It would also be possible to generate the 3D model using the techniques defined here, and to save a series of views from a fly-through as a linear video. By saving different fly-throughs or replays, it would be possible to offer some interactive choice on interfaces such as DVD or sports broadcasts for example, where there may be minimal navigational controls.

Because the image processing defined here is meant to separate foreground objects from the background and create depth perception from motion parallax, there is also a good fit for use of the model in MPEG-4 video. The datasets and 3D models generated with these methods are compatible with the VRML 2.0 standards, on which the models in MPEG-4 are based.

In professional sports broadcasts in particular, it is quite common to move back and forth down the playing surface during a game while looking into the center of the field. Navigation may require controls for direction of gaze, separate from location and direction and rate of movement. These may be optional controls in 3D games but can also be set in viewers for particular modeling platforms such as VRML. These additional viewing parameters would allow us to move up and down a playing surface while watching the play in a different direction—and do with smooth movement, regardless of the numbers or viewpoints of the cameras used. With the methods disclosed here, it is possible to navigate through a scene without awareness of camera locations.

### Phase 7: Measurement Calibration and Merging

Phases 1, 2 and 3 above explained methods for extracting video mattes using motion parallax, compositing these depth-wise, inflating foreground objects and then texture-mapping the original images onto the resulting relief surfaces. Once any pixel is defined as a point in XYZ coordinate space, it is a matter of routine mathematics to calculate its distance from any other point. In the preferred embodiment, a version of the 3D video software includes a user interface. Tools are available in this area to indicate points or objects, from which measures such as distance or volume can be calculated.

We also want to allow merging with previous point clouds from other systems (e.g., laser range-finder). Both formats would need to be scaled before merging data points. For scaling, the user interface also needs to include an indicator to mark a reference object, and an input box to enter its length in the real world. A reference object of a known length could be included in the original photography on purpose, or a length estimate could be made for an object appearing in the scene. Once a length is scaled within the scene, all data points can be transformed to the new units, or conversions can be made on demand.

The ability to merge with other 3D models also makes it possible to incorporate product placement advertising in correct perspective in ordinary video. This might involve placing a commercial object in the scene, or mapping a graphic onto a surface in the scene in correct perspective.

### Phase 8: Web Cam for On-Screen Holograms

Once we can analyze parallax movement in video, we can then use the same algorithms if a web cam, DV camera or video phone is in use, to track movement in the person viewing. Moving to the side will let you look around on-screen objects, giving the illusion on-screen of 3D foreground objects. As can be seen from FIG. 2, the viewpoint parameter is modified by detecting user movement with the web cam. When the person moves, the 3D viewpoint is changed accordingly. Foreground objects should move proportionately more, and the user should be able to see more of their sides. In 3D computer games, left-right movement by the user can modify input from the arrow keys, mouse or game pad, affecting whatever kind of movement is being controlled. Motion detection with a web cam can also be used to control the direction and rate of navigation in interactive multimedia such as panoramic photo-VR scenes.

The method disclosed here also uses a unique method to control 3D objects and “object movies” on-screen. Ordinarily, when you move to the left when navigating through a room for example, it is natural for the on-screen movement to also move to the left. But with parallax affecting the view of foreground objects, when the viewpoint moves to the left, the object should actually move to the right to look realistic. One way to allow either type of control is to provide an optional toggle so that the user can reverse the movement direction if necessary.

### Phase 9: Online Sharing

An important part of the design of the technology disclosed here concerns media sharing, of both the software itself and 3D video output. The design of the software is meant to encourage rapid online dissemination and exponential growth in the user base. When a video fly-through is saved, a commercial software development kit is used to save a file or folder with self-extracting zipped compression in the sharing folder by default. This might include video content and/or the promotional version of the software itself. At the same time, when a 3D scene is saved, a link to the download site for the software can also be placed in the scene by default. The defaults can be changed during installation or in software options later.

The software is also designed with an “upgrade” capability that removes a time limit or other limitation when a serial number is entered after purchase. Purchase of the upgrade can be made in a variety of different retailing methods, although the preferred embodiment is an automated payment at an online shopping cart. The same install system with a free promotional version and an upgrade can also be used with the web cam software.

Using the methods disclosed here, home users for the first time have the capabilities (i) to save video fly-throughs and/or (ii) to extract 3D elements from ordinary video. As with most digital media, these could be shared through instant messaging, email, peer-to-peer file sharing networks, and similar frictionless, convenient online methods. This technology can therefore enable proactive, branded media sharing.

This technology is being developed at a time when there is considerable public interest in online media sharing. Using devices like digital video recorders, home consumers also increasingly have the ability to bypass traditional interruption-based television commercials. Technology is also now accessible for anyone to release their own movies online, leading us from broadcasting monopolies to the “unlimited channel universe”. The ability to segment, scale and merge 3D video elements therefore provides an important new method of branding and product placement, and a new approach to sponsorship of video production, distribution and webcasting. Different data streams can also be used for the branding or product placement, which means that different elements can be inserted dynamically using contingencies based on individualized demographics, location or time of day, for example. This new paradigm of television, broadcasting, video and webcasting sponsorship is made possible through the technical capability to separate video into 3D elements.

In the drawings and specification, there have been disclosed typical preferred embodiments of the invention and although specific terms are employed, they are used in a generic and descriptive sense only and not for purposes Of limitation, the scope of the invention being set forth in the following claims.

Embodiments of the invention in which an exclusive privilege or property is claimed:

1. A method for automatically segmenting a sequence of two-dimensional digital images into a navigable 3D model, said method including:
a) capturing image sequences and defining nearer matte layers and/or depth maps based on proportionately greater lateral motion;
b) generating a wireframe surface for background and foreground objects from the raw video data which has been captured and processed in step (a);
c) giving depth to foreground objects using either: silhouettes from different perspectives, center spines that protrude depthwise in proportion to the width up and down the object, or motion parallax information if available;
d) texture mapping the raw video onto the wireframe;
e) filling in occluded areas behind foreground objects, both on the background and on sides that are out of view, by stretching image edges in to the center of blank spots; and
f) sharpening surface images on nearer objects and blurring more distant images to create more depth perception, using either existing video software development kits or by writing image processing code that implements widely-known convolution masks, thereby automatically segmenting an image sequence into a 3D model.

2. The method for taking non-contact measurements of objects and features in a scene based on unit measures of 3D models generated from digital images, for engineering, industrial and other applications, whereby:
a) once the X, Y and Z coordinates have been defined for points or features, routine mathematics can be used to count or calculate distances and other measures;
b) if measures, data merging or calibrating are needed in a particular scale, users can indicate as few as one length for a visible reference object in a software interface, and XYZ coordinates can be converted to those units; and
c) an interface can allow the user to indicate where measurements are needed, and can show the resulting distances, volumes, or other measures.

3. The method for controlling navigation and viewpoint in 3D video, 3D computer games, object movies, 3D objects and panoramic VR scenes with simple body movement and gestures using a web cam to detect foreground motion of the user, which is then transmitted like mouse or keyboard inputs to control the viewpoint or to navigate.

4. The method of generating 3D models as defined in claim 1, wherein foreground mattes are extracted automatically and placed in depth using motion parallax, with no manual intervention required to place targets or mark objects.

5. The method of generating 3D models in claim 1, wherein a full 3D object can be generated from only 3 images, and partial shape and depth models can be developed from as few as 2 sequential or perspective images.

6. The procedure for generating geometric shape from 2 or 3 images in claim 5, wherein motion parallax could be used in video where the object is rotated from one perspective to another (rather than bluescreen photography or manual background removal) to automatically extract mattes of a foreground object's silhouettes in the different perspectives.

7. The method of generating 3D models in claim 1, wherein the images used to generate the 3D points and depth map or wireframe, are then also texture-mapped onto the depth map or wireframe to create a photorealistic 3D model.

8. The method of generating 3D models using motion parallax as defined in claim 1, based on a dynamic wireframe model that can change with the running video.

9. The method of generating 3D models in claim 1, using sequences of images from both video and/or still cameras which do not need to be in defined positions.

10. The method of generating 3D models in claim 1, wherein 3D models are generated automatically and only a single imaging device is required (although stereoscopy or multi-camera image capture can be used).

11. The method of automatically generating a 3D scene from linear video in claim 1, whereby the XYZ coordinates for points in the 3D scene can be scaled to allow placement of additional static or moving objects in the scene, as might be done for product placement.

12. The method of generating a 3D model as defined in claim 1, wherein image comparisons from frame to frame to identify differential rates of movement are based on “best” feature matches rather than absolute matches.

13. The method of generating 3D models in claim 1, wherein processing can occur during image capture in a 3D camera, or at the point of viewing, for example in a set-top box, digital media hub or computer.

14. The method by which processing can occur either at the point of imaging or viewing as defined in claim 2, whereby this is a method for automatically generating navigable 3D scenes from historical movie footage and more broadly, any linear movie footage.

15. The method of generating 3D models in claim 1, wherein the software interface includes optional adjustable controls for: the popout between foreground layer and background; keyframe frequency; extent of foreground objects; rate at which wire frame changes; and depth of field.

16. The method of generating hologram effects on ordinary monitors using a videoconferencing camera in claim 3, wherein the user can adjust variables including the sensitivity of changes in viewpoint based on their movements, whether their movement affects mouse-over or mouse-down controls, reversal of movement direction, and the keyframe rate.

17. The method of generating hologram effects on ordinary monitors in claim 3, wherein the user's body movements are detected by a video conferencing camera with movement instructions submitted via a dynamic link library (DLL) and/or a software development kit (SDK) for a game engine, or by an operating system driver to add to mouse, keyboard, joystick or gamepad driver inputs.

18. The method of generating 3D models in claim 1, wherein the XYZ viewpoint can move within the scene beyond a central or “nodal” point and around foreground objects which exhibit parallax when the viewpoint moves.

19. The method of generating 3D models in claim 1, wherein digital video in a variety of formats including files on disk, web cam output, streaming online video and cable broadcasts can be processed, texture-mapped and replayed in 3D, using software development kits (SDKs) in platforms such as DirectX or OpenGL.

20. The method of generating 3D models in claim 1, using either linear video or panoramic video with coordinate systems such as planes, cylinders, spheres or cubic backgrounds.

21. The method of generating 3D models in claim 1, wherein occlusions can also be filled in as more of the background is revealed, by saving any surface structure and images of occluded areas until new information about them is processed or the initially occluded areas are no longer in the scene.

22. The method for controlling navigation and viewpoint with a videoconferencing camera in claim 3, wherein moving from side to side is detected by the camera and translated into mouse drag commands in the opposite direction to let the user look around foreground objects on the normal computer desktop, to have the ability to look behind windows on-screen.

23. The method of generating 3D models in claim 1, wherein separated scene elements can be transmitted at different frame rates to more efficiently use bandwidth, using video compression codecs such as MPEG-4.

24. The method of generating 3D models in claim 1, wherein the motion analysis automatically creates XYZ points in space for all scene elements visible in an image sequence, not just one individual object.

25. The method of generating 3D models in claim 1, wherein trigonometry can be used with images from different perspectives to convert cross-sectional widths from different angles to XYZ coordinates, knowing the amount of rotation.

26. The method of using object silhouettes from different angles to define object thickness and shape in claim 25, wherein the angle of rotation between photos can be given in a user interface, or the photos can be shot at pre-specified angles for fully automatic rendering of the 3D object model.

27. The method of defining center spines to define the depth of 3D objects as defined in claims 1 and 25, wherein the depth of the object can be defined by one edge down a center ridge on the object, or can be a more rounded polygon surface, with the sharpness of corners being an adjustable user option.

28. The method of generating 3D models in claim 1, wherein triangles are generated on outer object data points to construct a wireframe surface, using columns (or rows) of pairs of data points to work up the column creating triangles between three of the four coordinates, and then down the same column filling in the square with another triangle, before proceeding to the next column.

29. The method of generating 3D wireframe models using triangular polygons as defined in claim 28, wherein the user has an option to join or not join triangles from object edges to the background, creating a single embossed surface map or segmented objects.

30. The method of surface-mapping source images onto wireframe models defined in claim 1, wherein the software can include a variable to move the edge of a picture (the seam) to show more or less of the image, to improve the fit of the edge of the image.

31. The method of generating 3D models from images in claim 1, wherein ambiguity about a moving object's speed, size or distance is simply resolved by placing faster-moving objects on a nearer layer, and allowing the realism of the image to overcome the lack of precision in the distance.

32. The method of generating 3D models from images in claim 1, wherein we compare one frame to a subsequent frame using a “mask” or template of variable size, shape and values that is moved pixel by pixel through an image to track the closest match for variables such as intensity or color of each pixel from one frame to the next, to determine moving areas of the image.

33. The method of detecting movement and parallax in claim 32, wherein an alternative to defining foreground objects using masks is to define areas that change from frame to frame, define a center point of each of those areas, and track that center point to determine the location, rate and direction of movement.

34. The method of processing image sequences in claim 1, wherein it is possible to reduce the geometric calculations required while maintaining the video playback and a good sense of depth, with adjustable parameters that could include: a number of frames to skip between comparison frames, the size of a mask, the number of depth layers created, the number of polygons in an object, and search areas based on previous direction and speed of movement.

35. The methods of generating and navigating 3D models in claims 1 and 3, wherein a basic promotional version of the software and/or 3D models and video fly-throughs created can be zipped into compressed self-executing archive files, and saved by default into a media-sharing folder that is also used for other media content such as MP3 music.

36. The method of generating 3D models from images in claim 1, wherein:
a) as a default, any 3D model or video flythrough generated can include a link to a website where others can get the software, with the XYZ location of the link defaulting to a location such as (1,1,1) that could be reset by the user, and
b) the link could be placed on a simple shape like a semi-transparent blue sphere, although other objects and colors could be used.

37. The method of generating 3D models from images in claim 1, wherein either continuous navigation in the video can be used, or one-button controls for simpler occasional movement of viewpoint in predefined paths.

38. The method of generating depth maps from images in claim 1, wherein rather than a navigable 3D scene, distance information is used to define disparity in stereo images for viewing with a stereoscope viewer or glasses that give different perspectives to each eye from a single set of images such as red-green, polarized or LCD shutter glasses.

39. A method for automatically segmenting a two-dimensional image sequence into a 3D model, said method including:
a) a video device used to capture images having two-dimensional coordinates in a digital environment; and
b) a processor configured to receive, convert and process the two-dimensional images that are detected and captured from said video capturing device; said system generating a point cloud having 3D coordinates from said two-dimensional images, defining edges from the point cloud to generate a wireframe having 3D coordinates, and adding a wiremesh to the wireframe to subsequently texture map the image from the video capturing device onto the wiremesh to display said 3D model on a screen.

40. The method of claim 39, wherein the processor system is located in a set-top box, a digital media hub or a computer.

41. The method of claim 39, wherein the image device is a video capturing device or a still camera.

42. The method of claim 39, wherein the video capturing device is a video-conferencing camera.

43. The method of any one of claims 39 to 42, wherein the processor further fills in occluded areas by stretching the 3D image edges into the center of the occluded areas.

44. The method of any one of claims 39 to 43, wherein the processor sharpens images that are in the foreground and softens or blurs the images that are further away in the background to create more depth perception.

45. The method of claim 39, wherein the processor includes adjustable controls.

46. The method of claim 45, wherein the adjustable controls regulate the distance between the foreground layer and the background layer and adjust the depth of field.

47. The method of claim 39, wherein the two-dimensional images are in any of a variety of formats including files on disk, web cam output, streaming online video and cable broadcasts.

48. The method of claim 39, using either linear video or panoramic video with coordinate systems such as planes, cylinders, spheres or cubic backgrounds.

49. The method of claim 39, wherein two-dimensional image silhouettes are used at different angles to define 3D object thickness and shape.

50. The method of claim 39, wherein the 3D viewpoint can move within a scene beyond a central or nodal point and around foreground objects which exhibit parallax.

51. The method of claim 3 for controlling navigation and viewpoint in a 3D video, 3D computer game, object movies, 3D objects and panoramic VR scenes by using a video conferencing camera, wherein the user's movements are used to control the orientation, viewing angle and distance of the viewpoint for stereoscopic viewing glasses.

52. The method of claim 51, wherein the stereoscopic viewing glasses are red-green anaglyph glasses, polarized 3D glasses or LCD shutter glasses.

53. The method of generating 3D models as defined in claim 1, wherein the software interface includes an optimal adjustable control to darken the background relative to foreground objects, which enhances perceived depth and pop-out.

54. The method of generating 3D models as defined in claim 4, wherein credibility maps can be assessed along with shift maps and depth maps for more accurate tracking of movement from frame to frame.

55. The method of analyzing movement to infer depth of foreground mattes as defined in claim 4, wherein embossed mattes can be shown that remain attached to the background.

56. The method of analyzing movement to infer depth of foreground mattes as defined in claim 4, wherein embossed mattes can be shown as separate objects that are closer to the viewer.

57. The method of generating 3D models as defined in claim 1, wherein camera movement can be set manually for movement interpretation or calculated from scene analysis.

58. The method of claim 57, wherein the camera is stationary.

59. The method of claim 57, wherein type of camera movement can be lateral.

60. The method of claim 57, wherein the type of camera movement is uncontrolled.

61. The method of generating 3D models of claim 15, wherein the software interface can be adjusted according to the detection frames to account for an object that pop outs to the foreground or back into the background to improve stable and accurate depth modeling.

62. The method of generating stereoscopic views as defined in claim 38, wherein left and right-eye perspectives are displayed in binoculars to produce depth pop outs.

63. The method of rendering navigable video as defined in claim 14, wherein the default for navigation is to limit the swing of the viewpoint to an adjustable amount.

64. The method of claim 63, wherein the default swing is a defined amount in any direction.

65. The method of claim 64, wherein the defined amount is about 20 degrees in any direction.

66. The method of rendering navigable video as defined in claim 14, wherein the default is to auto return the viewpoint to the start position.

67. The method of rendering navigable 3D scenes from video as defined in claim 14, wherein movement control can be set for keyboard keys and mouse movement allowing the user to move around through a scene using the mouse while looking around using the keyboard.

68. The method of rendering navigable 3D scenes for video as defined in claim 14, wherein movement control can be set for mouse and keyboard keys movement allowing the user to move around through a scene using the keyboard keys while looking around using the mouse.
